(19) United States
(12) Patent Application Publication
(10) Pub. No.: US 2025/0159015 A1
(43) Pub. Date: May 15, 2025

(54) SYSTEMS AND METHODS FOR MODEL-BASED CYBER VULNERABILITY ASSESMENT

(71) Applicant: Nightwing Group, LLC, Dulles, VA (US)

(72) Inventors: William G. Pence, Clearwater, FL (US); Brandon K. Ward, Tampa, FL (US)

(21) Appl. No.: 18/941,014

(22) Filed: Nov. 8, 2024

Related U.S. Application Data
(60) Provisional application No. 63/598,371, filed on Nov. 13, 2023.

(51) Int. Cl. H04L 9/40

(52) U.S. Cl. CPC H04L 63/1433; H04L 63/0272

(57) ABSTRACT

A system includes one or more processors configured to collect data at multiple levels from a target environment via one or more cyber vulnerability (C V) data collection modules, the multiple levels comprising a network level, a platform level, and a binary level. The one or more processors are further configured to analyze the collected data, via a correlation engine, to identify relationships between entities in the collected data across the multiple levels, and to derive one or more blocks representative of the entities. The one or more processors are additionally configured to create one or more links between the one or more blocks based on the identified relationships, and to construct, via a model generator, a CV attack surface model comprising the one or more blocks connected via the one or more links.

### REFERENCE TO RELATED APPLICATION

This application claims priority to U.S. provisional patent application No. 63/598,371, filed on Nov. 13, 2023, which is incorporated herein by reference in its entirety.

### TECHNICAL FIELD

The present disclosure generally relates to cyber vulnerability assessment, and more specifically, to model-based cyber vulnerability assessment.

### BACKGROUND

Cyber Vulnerability Assessment (CVA) identifies and evaluates potential weaknesses and security gaps within an organization's digital infrastructure. It involves an examination of an organization's network, systems, and applications to pinpoint vulnerabilities that could be exploited by malicious actors. By conducting a CVA, organizations can proactively identify and prioritize vulnerabilities, allowing them to take proactive measures to strengthen their cybersecurity posture and protect sensitive data from cyber threats.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 illustrates a block diagram of a CVA modeling system suitable for cyber analysis and CVA model creation, according to some examples.

FIG. 2 illustrates an example CV attack surface model that has been generated by a CVA model generator, according to some examples.

FIG. 3 illustrates a flowchart of an example process for analyzing CV data at various levels and for automatically generating CV attack surface models, according to some examples.

FIG. 4 illustrates a screenshot of an example visual network sniffing agent, according to some examples.

FIG. 5 illustrates a screenshot of an example visual OS query agent, according to some examples.

FIG. 6 illustrates a screenshot of various example windows useful in providing for binary level analysis, including output from a threat intelligence feed, according to some examples.

FIG. 7 is a diagrammatic representation of a machine in the form of a computer system within which a set of instructions may be executed to cause the machine to perform any one or more of the methodologies discussed herein, according to some examples.

### DETAILED DESCRIPTION

Cyber vulnerabilities in computer systems and networks are a security concern for organizations. Attackers can exploit vulnerabilities to gain unauthorized access, steal data, disrupt operations, and so on. Identifying and mitigating vulnerabilities include the use of cyber vulnerability assessments (CV As). CV As are traditionally manually performed to systematically map the attack surface of a computer system or network, identify vulnerabilities, and evaluate severity of vulnerabilities based on attack surface.

The techniques described herein automatically generate one or more cyber vulnerability (C V) attack surface models for a target computer system under investigation. The models provide a more comprehensive representation of the attack surface and potential vulnerabilities based on data collected from the system at multiple levels—network, platform, and binary.

A model-based CVA system described herein includes data collection modules, a correlation engine, and a model generator. The data collection modules use existing tools in a plug-and-play manner to gather data from the target system at the network, platform, and binary levels. This data includes but is not limited to:
Network level—open ports, services, internet protocol (IP) addresses, and/or network traffic sniffing
Platform level—Operating system level applications, processes, configurations, and/or libraries
Binary level—executables, application level libraries, custom configurations

The correlation engine analyzes the collected data to identify relationships between different components and subsystems of the target system. These relationships may be based on interprocess communications, code dependencies, memory sharing, network connections, and so on. The model generator uses the correlated data to automatically construct a multi-level, hierarchical, CV model representing the attack surface. This CV attack surface model includes interactive blocks for each software component or subsystem. Each block may be expanded to reveal lower level details. The blocks are connected based on the identified relationships. The connections are presented via links, which include colored links, to denote importance and/or vulnerability level of connections. Likewise, the blocks include colored blocks with colors representative of importance and/or vulnerability level of the entity represented by the block, such as a positive virus scanned file colored red, an open port that is unexpectedly associated with a web server as colored yellow, and negative virus scan on a file colored green. The CV attack surface model can be generated at various points in time, creating a delta or a difference between CV attack surface models that can be used to determine attack exposure growth/shrinkage, impact of installing/deinstalling certain software, impact of operating system (OS) changes, and the like.

The CV attack surface model provides a graphical and interactive representation of the potential attack vectors and vulnerabilities in the target system. CVA analysts can easily trace connections and dependencies across multiple levels to identify risks. The automated generation saves time and effort compared to manual analysis and modeling. The model can be updated manually or automatically by re-running data collection to identify any changes in the attack surface and to create a library of delta differences. Accordingly, a more efficient CVA process is provided, which improves efficiency and secure operations for organizations.

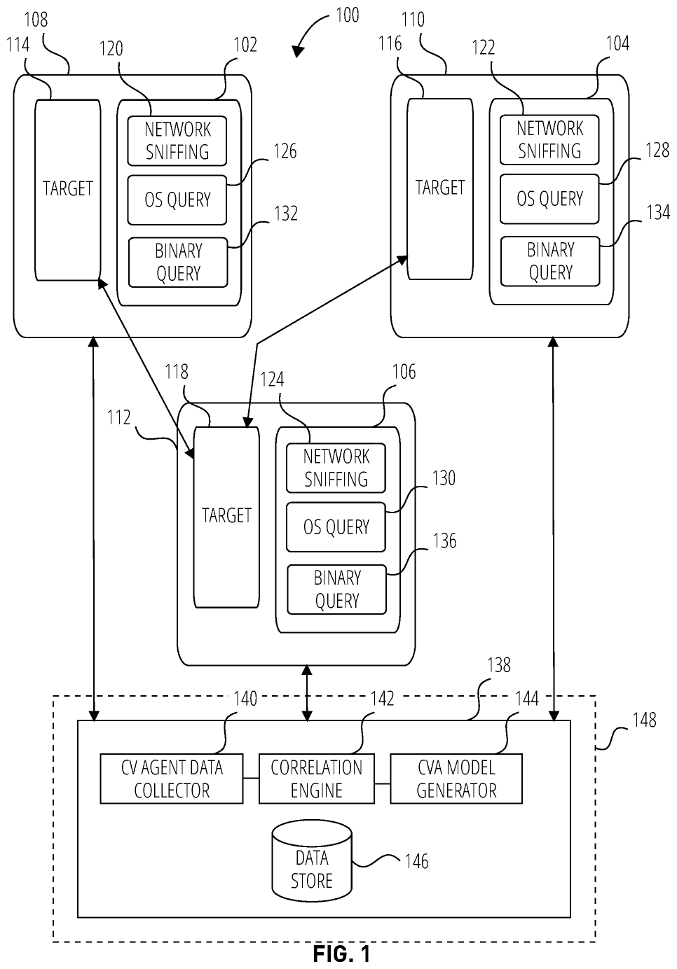

Turning now to FIG. 1, the figure is a block diagram of a CVA modeling system 100 suitable for cyber analysis and for CVA model creation, according to some examples. In the depicted example, the CVA modeling system 100 includes one or more CV agents 102, 104, 106. The CV agents 102, 104, 106 are disposed in various computing environments 108, 110, 112. In the depicted non-limiting example, the computing environment 108 is a Windows@ environment, the computing environment 110 is a Linux@ environment, and the computing environment 112 is a macOS@ environment. Each computing environment 108, 110, 112 includes one or more targets 114, 116, 118 for CVA analysis. For example, the targets 114, 116, 118 can include network level, platform level, and/or binary level targets such as open network ports, operating system (OS) processes under execution, dynamic link libraries (dlls), and so on.

Accordingly, each CV agent 102, 104, 106 includes network sniffing agents 120, 122, 124, OS query agents 126, 128, 130, and binary query agents 132, 134, 136, respectively. The CV agents 102, 104, 106 can each include more than one network sniffing agent, OS query agent, and binary query agent. Further, the CV agents 102, 104, 106 use a plug-and-play architecture so that new network sniffing agents, OS query agents, and/or binary query agents can be more easily added, updated, and/or removed. The network sniffing agents 120, 122, 124 use network port scanners like Nmap to identify open ports and associated services, and network sniffers, including open source sniffers such as Wireshark, to capture packets, protocols, connections, and so on. The network sniffing agents 120, 122, 124 extract IP addresses, domain names, server names that the targets 114, 116, 118 connect to and identify applications and services communicating over networks used by the computing environments 108, 110, 112.

The OS query agents 126, 128, 130 capture a currently used OS, an OS version, patches installed, configurations used, as well as procure a list of all processes currently running along with process details like binaries, users, configurations used when launching executables, and so on. The OS query agents 126, 128, 130 also identify and provides a list of services, daemons, system-level applications, and the like. The OS query agents 126, 128, 130 additionally provide a list of all libraries loaded by various processes, CPU usage data for each process, memory usage data for each process, permissions assigned to each process, permissions assigned to each user, and so on.

The binary query agents 132, 134, 136 focus on executable files, such as computer software and libraries (e.g., dynamic link libraries (dlls), shared libraries). The binary query agents 132, 134, 136 additionally analyze configuration files and help files. In operation, the binary query agents 132, 134, 136 perform analysis on executables, libraries, configuration files and help files to extract metadata like imports, exports, strings, and so on. The binary query agents 132, 134, 136 additionally scan binaries for vulnerabilities and malware using tools like virus scanners, rule-based systems, and binary signature analysis (e.g., a hash of a file). The binary query agents 132, 134, 136 also identifies compiler, security (e.g., address space layout randomization (ASLR)), and linker options used to build the binaries, and extract embedded resources like icons, manifests, certificates, and the like.

A CV manager 138 is then communicatively and operatively coupled to the CV agents 102, 104, 106. The CV manager 138 includes a CV agent data collector 140, a correlation engine 142, and a CVA model generator 144. The CV agent data collector 140 interfaces with the various CV agents 102, 104, 106 to collect network, platform, and binary level information provided by the network sniffing agents 120, 122, 124, the OS query agents 126, 128, 130, and the binary query agents 132, 134, 136, and stores the collected data in a data store 146.

The correlation engine 142 analyzes the data collected by the various data collection modules to identify relationships and dependencies between different components and subsystems of the target system. The correlation engine 142 then constructs process relationship graphs based on process relationships (e.g., parent-parent and/or parent-child process hierarchies), and builds dependency maps between processes and libraries using library load information. The correlation engine 142 additionally links processes to network connections by mapping open ports and sockets and determining which ports and sockets are being used by what processes. The correlation engine 142 also identifies code relationships between binaries based on imports, exports, calls, symbols, and links processes to file system resources using file access logs and handles. The correlation engine 142 is also suitable for building network architecture diagrams showing data flows between IP addresses/domains.

In some examples, the correlation engine 142 further identifying lateral movement paths across the system based on credential overlaps, and models access control relationships between users, processes, and/or resources. The correlation engine 142 stores the correlated data in the data store 146, and provides application programming interfaces (APIs) for the CVA model generator 144 to query this data. The correlational analysis creates a comprehensive picture of dependencies and relationships across the different subsystems and levels. This enables generating a more accurate multi-layered CV model.

The CVA model generator 144 takes the correlated data from the correlation engine 142 and automatically constructs a CV attack surface model representing the attack surface of the target system, e.g., targets 114, 116, and/or 118. The attack surface refers to the sum of the different points where an unauthorized user or agent (attacker) can try to gain entry into a computing environment, such as the computing environments 108, 110, 112, for example, to extract data, add certain software (e.g., viruses, data loggers, and so on), from a system, and more generally, to exploit certain weaknesses in the computing environment and/or associated network devices. The CV attack surface model depicts relationships and dependencies between system components that can be potentially leveraged in an attack, and aims to provide a holistic view of how different systems, users, processes and external entry points are interconnected.

In certain examples, the CVA model generator 144 first creates a hierarchical model modeling the overall architecture across network, platform, and binary levels. Elements at each level are added as blocks/nodes. The blocks/nodes may be representative of an attack point that can be leveraged to gain unauthorized access. At the network level, CVA model generator 144 adds blocks for external servers, domains, IP addresses that the system connects to, along with the associated ports and protocols. At the platform level, the CVA model generator 144 creates blocks for each process, service, and/or application running on the system. OS and filesystem details are also modeled. At the binary level, blocks are added for executables, libraries, modules configuration files, help files, and so on, loaded into various processes. The CVA model generator 144 the analyzes the correlated data to connect these blocks based on identified relationships. The relationships include network connections between blocks, process hierarchies, library dependencies, code relationships, configuration file sharing, help file sharing, and so on.

The CVA model generator 144 assigns certain attributes to each block derived from the collected data, such as process metadata (e.g., process name, binary signatures, network artifacts etc.) Interactive controls are added to each block to allow analysts to expand/collapse them as needed. Nested sub-blocks are generated when expanding a block. Links are also added to interconnect related blocks across levels based on analyzed relationships. The resulting model provides a clickable visual representation of the attack surface with the ability to interactively traverse dependencies and connections across multiple levels. The CVA model generator 144 also allows updating the model by re-running data collection modules and correlation engine to identify any changes or deltas in the attack surface over time.

It is to be noted that the techniques described herein also provide for CVA analysis in “air-gapped” settings or organizations. An air-gapped setting as referred to herein is a collection of one or more of computing environments (e.g., computing environments 108, 110, 112) that are physically and logically disconnected from other networks and the internet. In such an environment, there are no network connections or communication channels that can transmit data or information to or from the isolated system. Air-gapped system are physically disconnected from any external networks, typically by using physical barriers such as physically disconnected network cables, dedicated hardware, or even by placing the system in a physically secure location. Air-gapped systems have no direct or indirect access to the internet. Access to an air-gapped system is restricted, and any interactions with external devices or systems are carefully controlled and monitored. Data transfer to or from the isolated system typically requires manual processes and physical media and secure data transfer stations.

In air-gapped settings, the CV manager 138 can be hosted by a secure laptop 148 or similar computer system. The secure laptop 148 has built-in hardware security features like Trusted Platform Module (TPM) chips, secure boot mechanisms, and hardware encryption support to protect against physical attacks and tampering. In use, the secure laptop 148 is physically secured and monitored to prevent unauthorized access or removal. Further the secure laptop 148 has all wireless interfaces (Wi-Fi, Bluetooth, cellular) disabled or physically removed to prevent inadvertent or deliberate wireless communication. Other features of the secure laptop 148 include firmware and bootloaders that are securely configured to only allow trusted and signed operating system and software components to run. Data stored on the laptop's storage devices is encrypted to protect against physical theft or compromise. Accordingly, the CVA analysis can be performed in air-gapped settings and/or other environments to produce, for example, CV attack surface models as further described below.

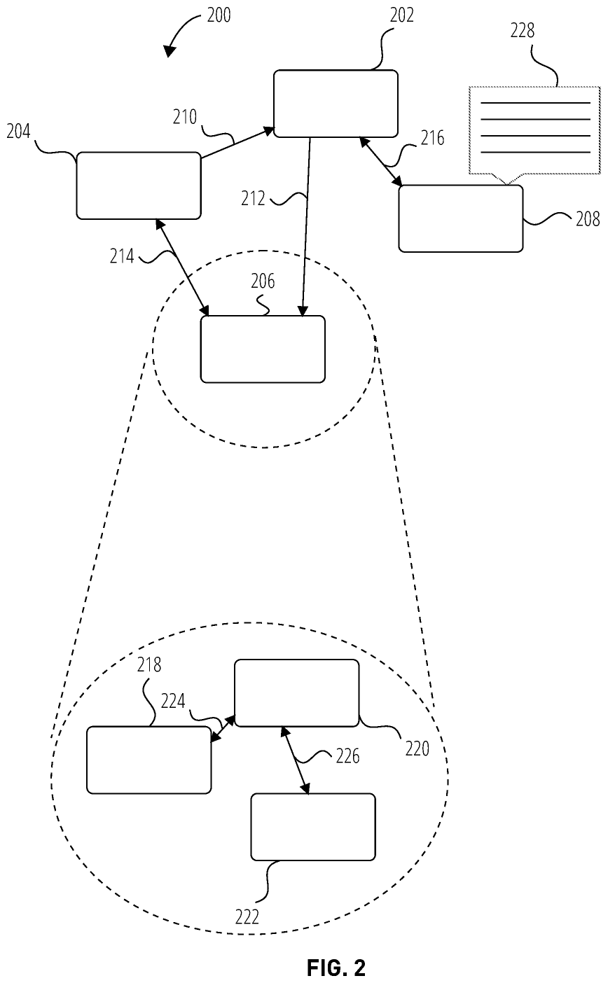

FIG. 2 illustrates an example CV attack surface model 200 that has been generated by the CVA model generator 144, according to some examples. In the depicted example, the CV attack surface model 200 includes a network-level block 202 representative of a local domain name system (DNS) server. The DNS 202 reads from a configuration file (block 204) to configure the DNS as a principal name server, a secondary name server, or a cache-only name server. The configuration file 204 is updated via a graphical user interface (GUI) configurator application shown as block 206. The configurator application 206 also reads an existing state of the DNS 202 and presents the existing state to aid in configuring the DNS 202 via the configuration file 204. Also shown is a heartbeat application represented as block 208. During operations, the heartbeat application 208 monitors the DNS 202 and can restart the DNS 202 based on certain conditions.

A one-directional link 210 is shown, representative of read-only access of the DNS 202 to the configuration file 204. Likewise, a one-directional link 212 is also shown, representative of the configuration application 206 reading state and other information from the DNS 202. A bi-directional link 214 is shown, illustrating a read/write access to the configuration file 204 by the configuration application 206. A second bi-directional link 216 is also included in the CV attack surface model 200, representative of the heartbeat application's ability to read state information from the DNS 202 and to restart the DNS 202 based on certain conditions.

The blocks 202-208 and the links 210-216 are displayed visually as a graph, and can include certain colors, for example, to focus the user on certain blocks and/or links that may benefit from extra analysis. For example, the color red is used to display blocks that have suspect virus scans and/or suspect hash signatures. That is, a virus scanner detects that a certain binary has an issue. Likewise, a hashing service uses the binary file's hash as input (e.g., as a binary file “signature”) and then responds that binary file has been known to contain suspect or vulnerable code. Accordingly, the binary file's block is colored red. Yellow is used to denote blocks and/or links that, while not known to have specific issues, may benefit from extra analysis due to certain conditions such as the use of a programming language to compile a binary file where the programming language doesn't have bounds checking or automatic memory management (e.g., the “C” programming language), programming languages that don't have runtime type checking, custom web servers developed in-house, processes that have a large number of open ports, and so on. Green is used to denote blocks and/or links that have passed certain virus scanner checks, hash checks, are known to be more secure, and so on.

Users, such as CVA analysts, can navigate the CV attack surface model 200 to explore further details found in the blocks. In the depicted example, activating the block 206 (e.g., by double-clicking) will then show details of one or more levels below by expanding the block 206 to reveal blocks 218, 220, 222. Block 218 is representative of certain shared libraries that the configuration application 206 uses, such as network (e.g., tcp/ip) libraries used to communicate by using certain ports, transmitting various packets, receiving data via interprocess communication (TPC), and so on. Block 220 is representative of the binary file that contains the main executable computer code of the configuration application. Block 222 is also shown, which is representative of a separate computer executable used for data logging. That is, the main executable 220 will use IPC and/or shared memory to transmit data to the executable 222 for logging purposes. It is to be noted that the model 200 enables multi-level navigation. That is, a block can be selected and navigated to see more block details (e.g., lower level navigation) or navigated to an upper level to see a more abstract view. Model levels include a network level (highest level), a platform level (middle level), and a binary level (lowest level).

Also shown are bi-directional links 224, 226. The bi-directional link 224 is colored red since the network library is frequently calling the main binary file of the configuration application and/or writing some data in the main binary file. This more unusual behavior has been captured by observing, via the OS query agents 126, 128, and/or 130, library 218 processes launching the main binary file 220 at certain intervals. Binary query agents 132, 134, and/or 136 have also observed certain overwrites of the main binary file 220 by the library 218. Indeed, as mentioned previously, colors are used to better focus the CVA analyst's attention to areas of the model that would benefit from further attention.

In some examples, attributes for the blocks and/or links are displayed via callouts, such as the callout 228. The callouts can be shown by moving a mouse over a block or link. The attributes give further details of the blocks and/or links, such as names, vulnerabilities, and so on, as further described below. Accordingly, the CV attack surface model 200 shows attack points as blocks and/or as links in a graphical manner more easily viewable and understood by the user.

The CV attack surface model 200 can be generated at certain time intervals to capture deltas or differences in time. The CV attack surface model 200 can also be generated to capture deltas or differences after OS upgrades, after the installation of new software, after reconfiguration of certain settings, after the addition of new users, and so on. The CV attack surface model 200 allows CVA analysts to interactively traverse attack surface starting from network entry points down to the binary level. The automated generation of the CV attack surface model 200 improves efficiency and saves effort compared to manual analysis.

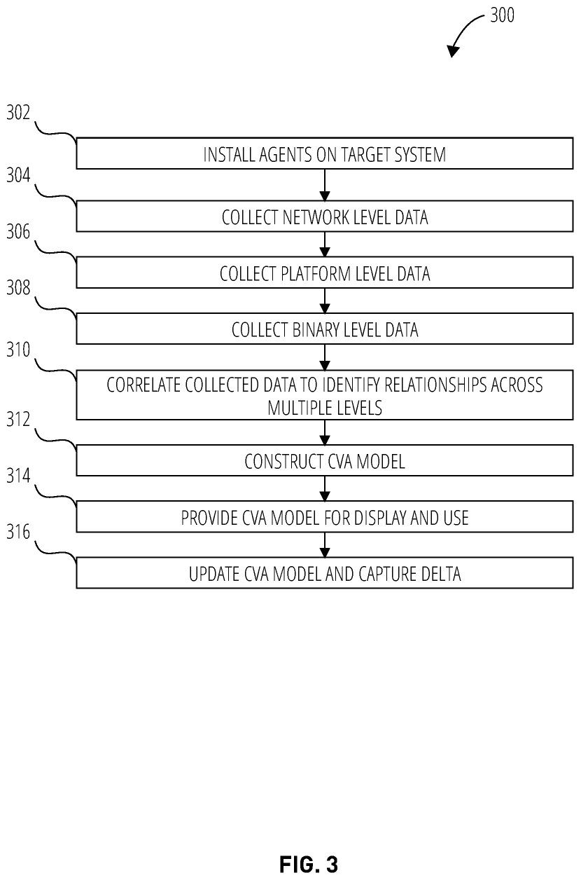

FIG. 3 illustrates a flowchart of an example process 300 for analyzing CV data at various levels and for automatically generating CV attack surface models, according to some examples. In the depicted embodiment, the process 300, at block 302, installs one or more CV agents, such as the CV agents 102. In some examples, the CV agents 102, 104, 106 are target environment-specific, e.g., Linux-specific, macOS-specific, Windows-specific, iOS-specific, Android-specific, Chrome OS-specific, a bare-metal OS (e.g., OS with minimal functionality), an embedded OS, a real-time OS, and so on. Accordingly, the CV agents 102, 104, 106 are installed based on their environment-of-use, e.g., via Linux package installers, macOS@ installers, Windows@ installers, iOS@ installers, Android@ installers, Chrome OS™ installers, bare-metal OS installers, embedded OS installers, real-time OS installers and so on. In air-gapped environments, secure data transfer stations that, for example, provide controlled access to removable media, such as USB drives, are used. The secure data transfer station additionally certain media handling procedures controlled to prevent malware introduction or data contamination.

Once the CV agents 102, 104, 106 are installed, the process 300 then collects, at block 304, network level data, for example, via the network sniffing agents 120, 122, 124. Collecting the network level data includes collecting information about the assets, configurations, and traffic patterns within a network. For example, an inventory of all network assets, including servers, routers, switches, firewalls, workstations, 10T devices, and any other connected devices can be created and or used, and a map of the network topology can also be created and/or used to better understand how devices are interconnected. This includes identifying subnets, VLANs, and network segments, and network infrastructure components such as routers, switches, and firewalls. Configurations of network devices (e.g., routers, switches, firewalls) are also extracted to aid in identifying potential misconfigurations and vulnerabilities. Network traffic analysis then captures and analyzes network traffic data to gain insights into normal traffic patterns and anomalies.

The network sniffing agents 120, 122, 124 use network monitoring tools to capture packet-level data (e.g., via Wireshark, tcpdump, and so on), flow data (e.g., via NetFlow, sFlow, and the like), and logs from network devices. Other tools include the use of Nmap to identify open ports and associated services. The network sniffing agents 120, 122, 124 extract IP addresses, domain names, server names that the targets 114, 116, 118 connect to and identify applications and services communicating over networks used by the computing environments 108, 110, 112. Accordingly, network entities can be identified, such as open ports, firewalls, routers, load balancers, web proxies, VPN gateways, web servers, virtual private network (VPN) gateways, database servers, email servers, DNS servers, Active Directory servers, file servers, print servers, remote access servers, network shares (e.g., shared files, shared folders), wireless access points, network switches, voice-over-internet protocol (VoIP) systems, private branch exchange (PBX) systems, storage area network (SAN) devices, network area storage (NAS) devices, network attached storage, virtualization hosts, hypervisors, and/or cloud instances. The network entities are identified based on a name of an executable (e.g., process) associated with an open port, a tcp/ip communication (e.g., identifier names in a tcp/ip packet), a file name, and so on. The network sniffing agents 120, 122, 124 then store the collected network level data in a data store such as the data store 146.

The process 300, at block 306, also collects platform level data, for example, via the OS query agents 126, 128, 130. Platform level data collected include the specific version and build number of the operating system, information about the OS kernel, including its version and release, details about the system's architecture (e.g., 32-bit or 64-bit), host name of the system on the network, hostname resolution (e.g., a mapping between hostnames and IP addresses), system uptime, and/or system manufacturer and model.

Platform level data collected also includes running process information, such as the name of each running process, a process ID, the user or account that initiated the process, the amount of CPU and memory resources used by each process, any parent process that spawned the current process, a timestamp indicating when the process was started (e.g., process timestamp), a file path to the executable binary of the process, and/or details of network connections opened by processes (e.g., listening ports, established connections). Other platform level data collected include system services, daemons, kernel drivers, applications, user accounts, user groups, user roles, privileges (user privileges, file privileges), filesystems, registry hives, configuration files, environment variables, scheduled tasks, startup scripts, containers (e.g., Kubernetes, Docker, and similar containers), serverless functions, script interpreters, development tools, compilers, debuggers, logs generated by the operating system, including system events, errors, and security-related logs, and/or virtual machines.

The process 300, at block 308, also collects binary level data, such as a name of a binary file (e.g., an executable file), a size of the binary file in bytes, access permissions granted to the file (e.g., read, write, execute) for different users and groups, creation, modification, and access timestamps of the file, and/or a format or file type (e.g., ELF for Linux@ executables, PE for Windows@ executables). Binary level data collected additionally include cryptographic hash values (e.g., MDS, SHA-256) computed for the binary file. These hashes are used to verify the integrity of the file and detect tampering. During operations, the binary file may be analyzed to determine how the binary behaves when executed, including interactions with the operating system and other processes. Other runtime data collected for the binary file includes monitoring system calls made by the binary during execution to detect potentially malicious or suspicious behavior, and observed network connections initiated by the binary to determine if it communicates with external entities. Other binary level data collected includes device drivers, kernel modules, scripts, static data files, font files, icon files, archive files, document files, media files, database files, SSL/TLS certificates, SSH keys, API keys, cryptographic keys, crypto wallets, licensing files, firmware images, virtual machine images, and/or container images.

Static analysis of the binary file is also performed, such as examination of the binary's machine code, assembly instructions, and control flow, identification of functions, symbols, and libraries used by the binary, and/or a determination of external libraries and system calls required by the binary. String analysis data is also collected, that searches for sensitive strings (e.g., passwords, application programming interface (API) keys) embedded within the binary. Binary level data collected additionally includes extracted version information and metadata embedded in the binary, as well as library and dependency information. Library and dependency information includes information about shared libraries (e.g., dynamic link libraries (dlls) on Windows, shared objects on Linux) used by the binary, including their versions, and identification of any missing or outdated library dependencies that may introduce vulnerabilities.

Other binary level data collected for a binary file includes determining the compiler and version used to compile the binary, collecting compiler flags and optimizations applied during compilation, extracting debugging information and symbols that can aid in vulnerability analysis and debugging, identifying any encryption mechanisms used to protect the binary's code or data, and/or detection of compressed sections within the binary. Binary level data collected additionally includes the use of static and dynamic analysis tools to identify vulnerabilities, buffer overflows, and potential security issues in the binary file. If the binary file is digitally signed, information about the digital signature, including the signing certificate and signing authority is collected. Likewise, identification of any software licenses or copyright notices embedded in the binary is collected. All collected binary level data is then stored in a data store, such as the data store 146.

The process 300 then correlates, at block 310, the collected data (e.g., network level data, platform level data, and binary level data) by analyzing the collected data from multiple sources to identifies relationships between components across network, platform, and binary levels. At a high level, techniques such as pattern matching (e.g., via neural networks), heuristic analysis, statistical analysis, and graph analysis are used. For example, to identify relationships, the process 300 looks for connections, such as network connections, by matching IP addresses, ports, and/or protocols between network, platform, and binary level data to link binaries and processes to external connections. Process hierarchies are also investigated, for example, parent-child process relationships based on PPID and/or process spawning order.

File access is also analyzed, such as file handles opened by processes and file locks indicating access patterns. IPC mechanisms are investigated as well, including shared memory, pipes, and/or socket connections between processes. Correlation analysis also includes library dependency analysis that determines links between executables and libraries loaded at runtime.

Code similarities are additionally investigated to determine component correlation, including the use of function call graphs, instruction sequences, constants, and the like, indicating code relationships. Likewise, links between configuration files, registry keys, environment variables and processes are analyzed. Execution artifacts are also correlated by correlating file creation and registry access with responsible processes. A timing analysis is also used for correlation, which identifies causality (e.g., file creation) based on event timing (e.g., launching of a binary). User context is used to derive correlative links between user accounts, processes being executed, and files accessed. Accordingly, the process 300 builds an internal graph representation capturing entities and relationships. Graph algorithms are then run to identify hidden relationships, and statistical techniques look for correlation between events. In some examples, the correlation at block 310 is performed by the correlation engine 142.

The process 300 then constructs, at block 312, a graph-based CVA model, such as the CV attack surface model 200. In certain examples, model blocks are first created, representative of entities such as network ports, network devices (e.g., routers, firewalls), processes, binary files, and so on. The blocks are then connected via links based on identified relationships. Each block and each link is assigned one or more attributes. Some non-limiting examples are as follows: For network level entities: Entity Name, IP addresses, Hostnames, Ports used, Protocols, Traffic volume, Geolocation, Network Device and Type (e.g., if the entity is a network device such as a router, switch, hardware firewall), and so on. For platform level entities: Entity Name, OS details, Users and groups associated with the entity, Process details (e.g., if the entity is a process, then CPU usage, memory usage, and so on), Ports used, and so on. For binaries entities: Name, Hash of binary file, Binary signatures, Compilation details, Linked libraries, Security settings, Symbols/functions, File permissions, Virus scan results, and so on. For links or interrelationships: Link name, Connection type (e.g., one-directional, bi-directional), Dataflow direction, Relationship details (e.g., why are the blocks connected, such as “opens a file”, launches an executable”, “opens a port”, and so on).

The process 300, at block 314, provides the CV attack surface model for display and use. That is, a user can visualize the CV attack surface model as a graph, then select certain blocks or portions of the model for further analysis, for example, by enabling navigation “inside” of blocks, by presenting pop-ups showing entity and link attributes, by providing for filtering (e.g., filter only network level entities, platform level entities, binary level entities, filter by name, filter by file size, and so on). The process 300, at block 316, updates the CV attack surface model to capture deltas or differences. In one example, the CV attack surface model is updated at a scheduled time. In other examples, the CV attack surface model is updated after installing certain OS patches, adding/removing/updating certain software, and/or adding/removing/updating certain hardware (e.g., network devices, workstations, laptops). The various models are then analyzed to determine deltas or differences. The differences can be representative of changes in attack surfaces between the CV attack surface models.

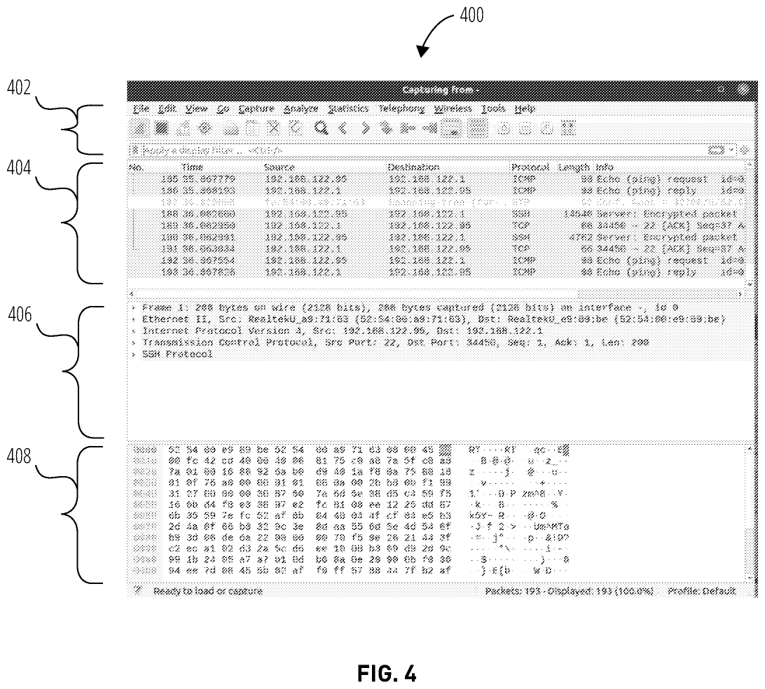

FIG. 4 illustrates a screenshot of an example visual network sniffing agent 400, according to some examples. In the depicted embodiment, the visual network sniffing agent 400 is a Wireshark-based agent, and includes sections 402, 404, 406, and 408. Section 402 is used to display an application menu, a toolbar, and a filtering textbox suitable for filtering certain information, such as internet protocol (IP) addresses. In use, the network sniffing agent 400 captures, in real-time, data packets being sent and received in a target environment, such as the computing environments 108, 110, 112. The network sniffing agent 400, for example, captures data packets by observing a network interface (e.g., network card) disposed in the target environment to capture data packets outgoing from the target environment and incoming into the target environment.

The section 404 then displays, by source IP address and destination IP address, a time that the data packet was sent, a communication protocol for the data packet, a length (e.g., in bytes) of the data packet, and other information for the data packet, such as application used to transmit the data packet, if the packet is encrypted, if the packet is a request or a reply, and so on. In the depicted example, data in section 404 is displayed in rows. Accordingly, a user selects a row in section 404 to see further details in section 406 and 408.

Section 406 illustrates summary information about the data packet, such as frame information, hardware device used to transmit or receive the packet, IP version used, and transmission control protocol information such as source port and/or destination port, protocol used, and the like. Section 408 then displays a hexadecimal and ASCII view of the payload in the data packet. In certain examples, the network sniffing agent 400 will additionally store the captured data packets for further analysis. By providing for network-level data capture via network sniffing agents such as the network sniffing agent 400, the techniques described herein enable a more comprehensive analysis of vulnerabilities and their severity.

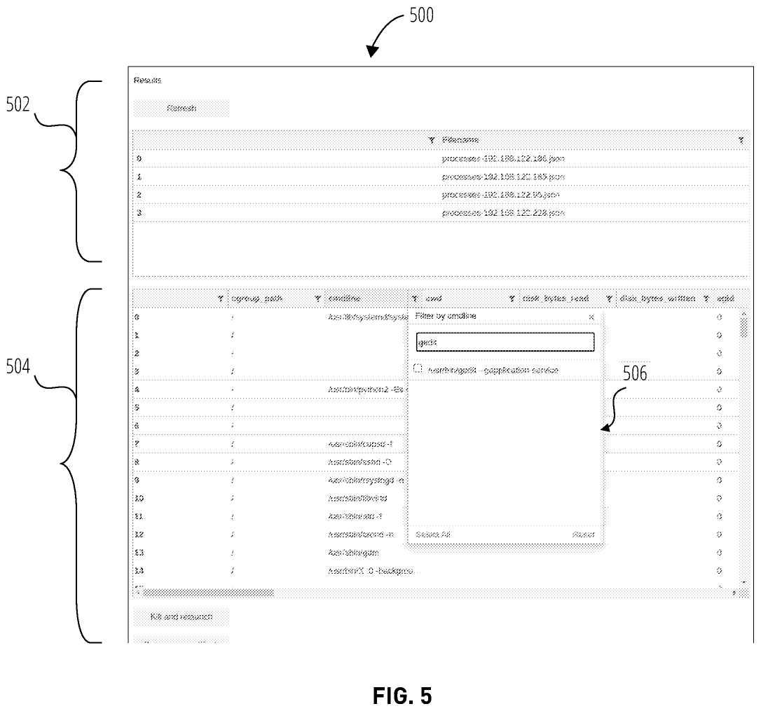

FIG. 5 illustrates a screenshot of an example visual OS query agent 500, according to some examples. In the depicted example, the visual OS query agent 500 includes two sections 502, 504. Section 502 displays a list of filenames that contain details on running processes, while section 504 displays a list of applications, daemons, system services, scripts, and so on, that are captured in the selected filenames in section 502. OS query agents, such as the OS query agent 500, are able to view running processes, as well as details on the running processes, file names associated with the running processes, settings provided via the command line, process ID, cgroup information, disk bytes read, disk bytes written, and so on. Cgroups allow the setting of resource limits and control the usage of CPU, memory, and other system resources by processes within a cgroup. This helps prevent resource contention and ensures that one process or group of processes doesn't monopolize system resources. Cgroups provide mechanisms for tracking resource usage and performance statistics for processes or cgroups. This information can be useful for CVA analysis. Also shown is a filter dialog box 506, suitable for filter information, including command line commands, process ID's, parent processes, children processes, and the like. Other similar OS query agents can include using a default task manager that is provided by the OS as well as third party tools that provide for OS level data collection.

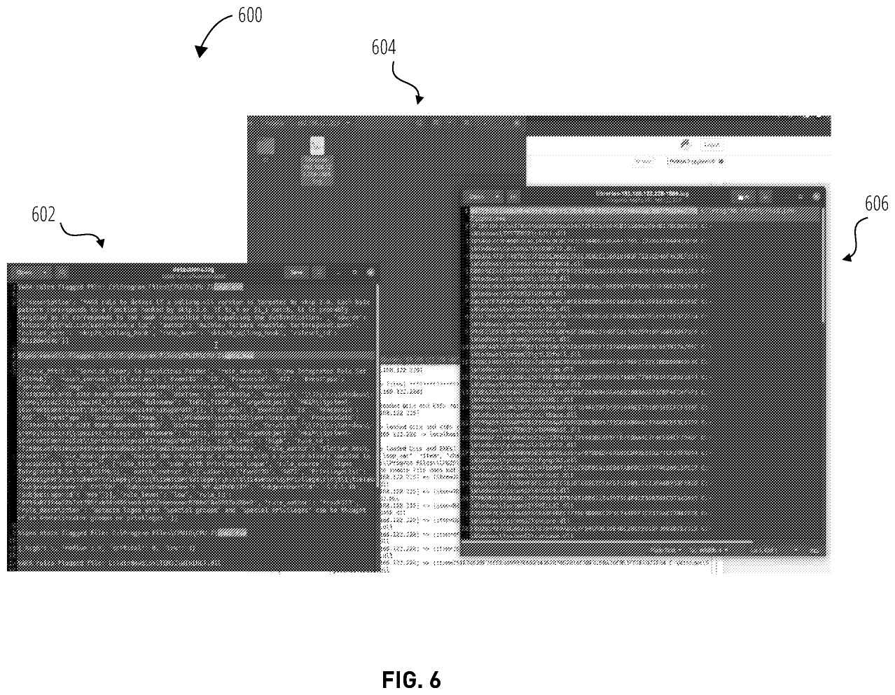

FIG. 6 illustrates a screenshot of various example windows 600 useful in providing for binary level analysis, including output from scanning threat intelligence feeds in window 602, according to some examples. The threat intelligence scan window 602 uses various threat intelligence feeds to scan one or more files, including binary files. Threat intelligence feeds (e.g., VirusTotal or Elastic Stack) can use a hash of the file or some other signature to match it against samples with known vulnerabilities or malware. Other threat intelligence feeds (e.g., cve-bin-tool or Intel® Owl) can operate directly on the binary file by using binary scanners to search for the existence of known vulnerable sub-components or search for patterns such as strings, byte sequences, or other data patterns that are associated with malware or specific file characteristics. Advanced binary scanners can use machine learning and artificial intelligence concepts to determine similarity with known vulnerable samples or by detecting vulnerable patterns in control flow. By applying threat intelligence feeds to extract knowledge on various files, a more comprehensive vulnerability assessment is provided when compared to using only a virus scanner.

Also shown is a filesystem window 604 showing certain files, including a libraries log file. A window 606 shows contents of the libraries log file. More specifically, the window 606 shows a list of various dynamic link libraries (dlls) that are used by the file (e.g., cpuz.exe) scanned via threat intelligence feeds. Information provided via the window 606 is then used to establish relationships and links between the file scanned by threat intelligence feeds and one or more dlls, shared libraries, configuration files, registry files, database files, and so on. The log file shown in the window 606 can be created via a binary file analysis that extracts use of the dlls. The binary file analysis additionally looks for a compiler used to compile executable files, linker settings, embedded API keys, embedded security certificates, and so on.

Various log files can be created, for example, via static application security testing (SAS T), dynamic application security testing (DAS T), a file integrity monitoring (FIM), and the like. SAS T tools perform a static analysis of the code, meaning they don't execute the application but examine it as-is, without running it. This makes SAS T more suitable for finding vulnerabilities that might not be apparent during dynamic testing (e.g., penetration testing or dynamic analysis). DAST is a type of software security testing methodology that focuses on evaluating the security of an application from the outside, while it is running. DAST is often referred to as “black-box testing” because it examines the application without knowledge of its internal code or structure. (F 1M) is a security mechanism and process that helps organizations monitor and validate the integrity of files and system configurations on their computer systems, servers, and network devices. FIM is designed to detect unauthorized changes, modifications, or tampering of critical files and configurations, which could indicate a security breach or compliance violation. Indeed, various binary level tools can analyze and save the analysis results, for example, in log files. By providing for multi-level agents, such as the those depicted in FIGS. 4-6, the techniques described herein automatically combine collected data to result in a more comprehensive CV attack surface model from monitored target environments.

### Machine Architecture

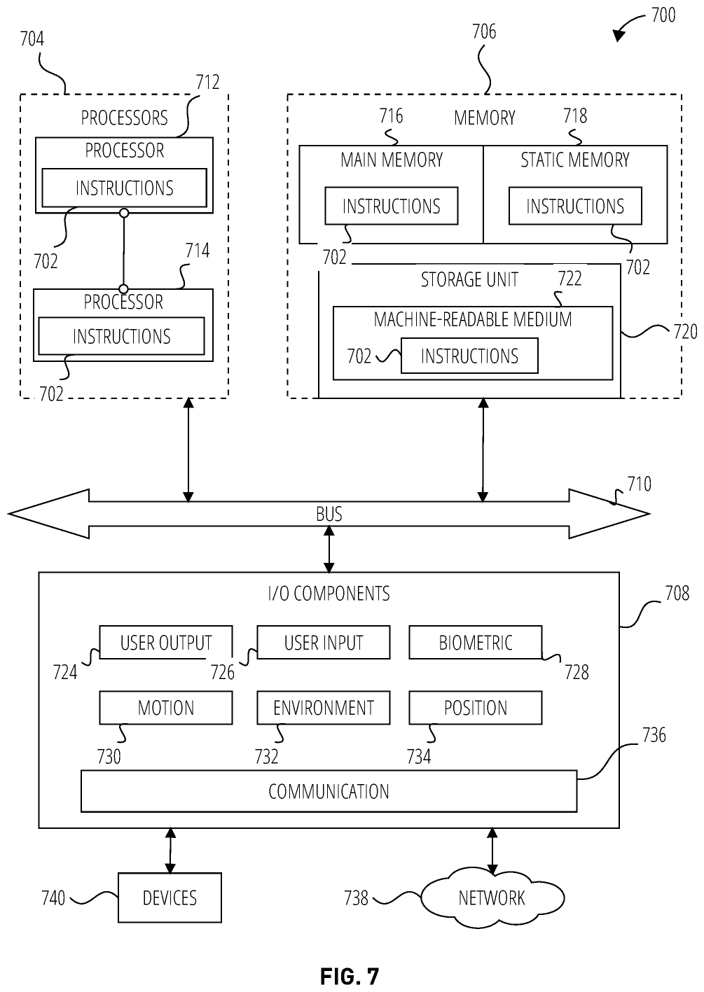

FIG. 7 is a diagrammatic representation of the machine 700 within which instructions 702 (e.g., software, a program, an application, an applet, an app, or other executable code) for causing the machine 700 to perform any one or more of the methodologies discussed herein may be executed. For example, the instructions 702 may cause the machine 700 to execute any one or more of the methods described herein. The instructions 702 transform the general, nonprogrammed machine 700 into a particular machine 700 programmed to carry out the described and illustrated functions in the manner described. The machine 700 may operate as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 702 sequentially or otherwise, that specify actions to be taken by the machine 700. Further, while a single machine 700 is illustrated, the term “machine” shall also be taken to include a collection of machines that individually or jointly execute the instructions 702 to perform any one or more of the methodologies discussed herein. The machine 700, for example, may comprise the CV agents 102, 104, 106, and/or the CV manager 138 or any one of multiple server devices forming part of the CVA modeling system 100. In some examples, the machine 700 may also comprise both client and server systems, with certain operations of a particular method or algorithm being performed on the server-side and with certain operations of the particular method or algorithm being performed on the client-side.

The machine 700 may include processors 704, memory 706, and input/output I/O components 708, which may be configured to communicate with each other via a bus 710. In an example, the processors 704 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 712 and a processor 714 that execute the instructions 702. The term “processor” is intended to include multi-core processors that may comprise two or more independent processors (sometimes referred to as “cores”) that may execute instructions contemporaneously. Although FIG. 7 shows multiple processors 704, the machine 700 may include a single processor with a single-core, a single processor with multiple cores (e.g., a multi-core processor), multiple processors with a single core, multiple processors with multiples cores, or any combination thereof.

The memory 706 includes a main memory 716, a static memory 718, and a storage unit 720, both accessible to the processors 704 via the bus 710. The main memory 706, the static memory 718, and storage unit 720 store the instructions 702 embodying any one or more of the methodologies or functions described herein. The instructions 702 may also reside, completely or partially, within the main memory 716, within the static memory 718, within machine-readable medium 722 within the storage unit 720, within at least one of the processors 704 (e.g., within the processor's cache memory), or any suitable combination thereof, during execution thereof by the machine 700.

The I/O components 708 may include a wide variety of components to receive input, provide output, produce output, transmit information, exchange information, capture measurements, and so on. The specific I/O components 708 that are included in a particular machine will depend on the type of machine. For example, portable machines such as mobile phones may include a touch input device or other such input mechanisms, while a headless server machine will likely not include such a touch input device. It will be appreciated that the I/O components 708 may include many other components that are not shown in FIG. 7. In various examples, the I/O components 708 may include user output components 724 and user input components 726. The user output components 724 may include visual components (e.g. a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 726 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 708 may include biometric components 728, motion components 730, environmental components 732, or position components 734, among a wide array of other components. For example, the biometric components 728 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components is used, for example, to gain authorization into the CVA modeling system 100.

Any biometric data collected by the biometric components is captured and stored only with user approval and deleted on user request. Further, such biometric data may be used for very limited purposes, such as identification verification. To ensure limited and authorized use of biometric information and other personally identifiable information (PI]), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

The motion components 730 include acceleration sensor components (e.g., accelerometer), gravitation sensor components, rotation sensor components (e.g., gyroscope). The environmental components 732 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 734 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 708 further include communication components 736 operable to couple the machine 700 to a network 738 or devices 740 via respective coupling or connections. For example, the communication components 736 may include a network interface component or another suitable device to interface with the network 738. In further examples, the communication components 736 may include wired communication components, wireless communication components, cellular communication components, Near Field Communication (NFC) components, Bluetooth® components (e.g., Bluetooth® Low Energy), Wi-Fi components, and other communication components to provide communication via other modalities. The devices 740 may be another machine or any of a wide variety of peripheral devices (e.g., a peripheral device coupled via a USB).

Moreover, the communication components 736 may detect identifiers or include components operable to detect identifiers. For example, the communication components 736 may include Radio Frequency Identification (RFTD) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 736, such as location via Internet Protocol (IP) geolocation, location via Wi-Fi@ signal triangulation, location via detecting an NFC beacon signal that may indicate a particular location, and so forth.

The various memories (e.g., main memory 716, static memory 718, and memory of the processors 704) and storage unit 720 may store one or more sets of instructions and data structures (e.g., software) embodying or used by any one or more of the methodologies or functions described herein. These instructions (e.g., the instructions 702), when executed by processors 704, cause various operations to implement the disclosed examples.

The instructions 702 may be transmitted or received over the network 738, using a transmission medium, via a network interface device (e.g., a network interface component included in the communication components 736) and using any one of several well-known transfer protocols (e.g., hypertext transfer protocol (HTTP)). Similarly, the instructions 702 may be transmitted or received using a transmission medium via a coupling (e.g., a peer-to-peer coupling) to the devices 740.

Technical effects include automating the construction of multi-level CVA models to eliminate manual modeling and analysis, and providing a CV attack surface model integrating network, platform and binary data. This enables identifying complex cross-level relationships and attack paths that span traditional tool boundaries. The CV attack surface model allows for interactive visualization and navigation of entities and relationships of interest, thus improving usability and understanding of security issues.

What is claimed is:

1. A system, comprising:
one or more processors configured to:
collect data at multiple levels from a target environment via one or more cyber vulnerability (CV) data collection modules, the multiple levels comprising a network level, a platform level, and a binary level, analyze the collected data, via a correlation engine, to identify relationships between entities in the collected data across the multiple levels; derive one or more blocks representative of the entities; create one or more links between the one or more blocks based on the identified relationships; and construct, via a model generator, a CV attack surface model comprising the one or more blocks connected via the one or more links.

2. The system of claim 1, wherein the one or more processors are further configured to identify relationships between entities, via the correlation engine, by matching internet protocol (IP) addresses, an open port, a communication protocol, a parent-child process relationship, a process spawning order, or a combination thereof, between a network level data, a platform level data, a binary level data, or a combination thereof, wherein the collected data comprises the network level data, the platform level data, the binary level data, or the combination thereof.

3. The system of claim 1, wherein the entities comprise at least one network level entity comprising a port, a communications protocol, a firewall, a router, a load balancer, a proxy, a virtual private network (VPN) gateway, a web server, a database server, an email server, a domain name system (DNS) server, an Active Directory server, a file server, a print server, a remote access server, a network share, a wireless access point, a network switch, a voice-over-internet protocol (VoIP) system, a private branch exchange (PBX) system, a storage area network (SAN) device, a network area storage (NAS) device, a network log, a virtualization host, a hypervisors, a cloud instance, or a combination thereof.

4. The system of claim 1, wherein the entities comprise at least one platform level entity comprising an operating system (OS), an OS version, an OS patch, a running process, a system service, a daemon, a running application, a running driver, a user name, a user group, a user role, a registry, an event log, a security log, an error log, a startup script, or a combination thereof.

5. The system of claim 1, wherein the entities comprise at least one binary level entity comprising an executable file, a database file, a security certificate, a dynamic link library (dll), a shared library, a device driver, a media file, a firmware file, an archive file, a document file, a virtual image file, or a combination thereof.

6. The system of claim 1, wherein the one or more processors are further configured to provide, via the model generator, an interactive visualization of the CV attack surface model.

7. The system of claim 6, wherein the interactive visualization comprises a graph-based visualization displaying the one or more blocks connected via the one or more links.

8. The system of claim 6, wherein the one or more blocks, the one or more links, or a combination thereof, are visualized using a color representative of an entity vulnerability level of an entity represented by one of the one or more blocks or of a link vulnerability level of a link of the one or more links.

9. The system of claim 6, wherein the interactive visualization comprises a graphical user interface (GUI) configured to receive a user selection of a block of the one or more blocks and to create a visualization of a lower level of the CV attack surface model or of an upper level of the CV attack surface model based on the block.

10. The system of claim 9, wherein the GUI is further configured to receive a second user selection of a link of the one or more links and to display one or more link attributes associated with the link.

11. The system of claim 1, wherein the one or more CV data collection modules comprise a network sniffing agent configured to capture data packets outgoing from the target environment and incoming into the target environment.

12. The system of claim 11, wherein the network sniffing agent comprises a GUI configured to visualize the captured packets by source IP address, by destination IP address, or a combination thereof.

13. The system of claim 1, wherein the one or more CV data collection modules comprise an operating system (OS) query agent configured to collect OS information for an OS running on the target environment, to collect process information for a list of all processes running in the target environment, to collect system information for a list of all system services running in the target environment, to collect daemon information for a list of all daemons running in the target environment, to collect application information for a list of all applications running on the target environment, or a combination thereof.

14. The system of claim 1, wherein the one or more CV data collection modules comprise a binary query agent configured to collect, for a file, a file name, a hash of the file, a compiler and a linker option used to compile and build the file, an embedded resources disposed in the file, an application programming interface (API) key embedded in the file, a signing certificate embedded in the file, a result of a vulnerability scan on the file, or a combination thereof.

15. The system of claim 14, wherein the vulnerability scan comprises a virus scan, a threat intelligence feed scan, a static application security testing (SAS T), a dynamic application security testing (DAS T), a file integrity monitoring (FIM), a binary file analysis, or a combination thereof.

16. The system of claim 1, wherein the target environment comprises a Linux environment, a Windows@ environment, a macOS@ environment, an iOS@ environment, an Android@ environment, a Chrome OS™ environment, a bare-metal OS environment, an embedded OS environment, a real-time OS environment, or a combination thereof.

17. A method for cyber vulnerability assessment (CVA), comprising.
collecting data at multiple levels from a target environment via one or more cyber vulnerability (C V) data collection modules, the multiple levels comprising a network level, a platform level, and a binary level, analyzing the collected data, via a correlation engine, to identify relationships between entities in the collected data across the multiple levels; deriving one or more blocks representative of the entities; creating one or more links between the one or more blocks based on the identified relationships; and constructing, via a model generator, a CV attack surface model comprising the one or more blocks connected via the one or more links.

18. The method of claim 17, further comprising identifying relationships between entities, via the correlation engine, by matching internet protocol (IP) addresses, an open port, a communication protocol, a parent-child process relationship, a process spawning order, or a combination thereof, between a network level data, a platform level data, a binary level data, or a combination thereof, wherein the collected data comprises the network level data, the platform level data, the binary level data, or the combination thereof.

19. A non-transitory machine-readable medium storing instructions that, when executed by a computer system, cause the computer system to perform operations comprising collecting data at multiple levels from a target environment via one or more cyber vulnerability (C V) data collection modules, the multiple levels comprising a network level, a platform level, and a binary level; analyzing the collected data, via a correlation engine, to identify relationships between entities in the collected data across the multiple levels; deriving one or more blocks representative of the entities; creating one or more links between the one or more blocks based on the identified relationships; and constructing, via a model generator, a CV attack surface model comprising the one or more blocks connected via the one or more links.

20. The non-transitory machine-readable medium of claim 19, wherein operations further comprise identifying relationships between entities, via the correlation engine, by matching internet protocol (IP) addresses, an open port, a communication protocol, a parent-child process relationship, a process spawning order, or a combination thereof, between a network level data, a platform level data, a binary level data, or a combination thereof, wherein the collected data comprises the network level data, the platform level data, the binary level data, or the combination thereof.
